(19) United States
(12) Patent Application Publication
(10) Pub. No.: US 2008/0228477 A1
(43) Pub. Date: Sep. 18, 2008

(54) Method and Device For Processing a Voice Signal For Robust Speech Recognition

(75) Inventors: Tim Fingscheidt, Braunschweig (DE); Panji Setiawan, Munchen (DE); Sorel Stan, Starnberg (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 10/585,747

(22) PCT Filed: Oct. 4, 2004
(86) PCT No.: PCT/EP04/52427

§ 371 Date: Jul. 12, 2006

(30) Foreign Application Priority Data
Jan. 13, 2004 (DE) 10 2004 001 863.4

(51) Int. Cl. G10L 15/20

(52) U.S. Cl. 704/233

(57) ABSTRACT

A speech signal is processed for subsequent speech recognition. The speech signal is tainted by noise and represents at least one speech command. The following steps are executed: a) recording of the noise-tainted speech signal; b) use of noise reduction on the speech signal to generate a noise-reduced speech signal; c) normalization of the noise-reduced speech signal to a target signal value with the aid of a normalization factor, to generate a noise-reduced, normalized speech signal).

The invention relates to a method and a device for processing a speech signal, which is tainted by noise, for subsequent speech recognition.

Speech recognition is being used to an increasing extent to facilitate the operation of electrical devices.

To enable speech to be recognized what is known as an acoustic model must be created. To this end, speech commands are trained, a process which can be undertaken for example—for the case of speaker-independent speech recognition—at the factory. Training here is taken to mean the creation of so-called feature vectors describing the voice command, based on speaking a voice command numerous times. These feature vectors (which are also called prototypes) are then collected into the acoustic model, for example a so-called HMM (Hidden Markov Model).

The acoustic model serves to determine from a given sequence of speech commands or words selected from the vocabulary, the likelihood of the observed feature vectors (during the recognition).

For speech recognition or recognition of flowing speech, in addition to an acoustic model a so-called speech model is also used, which specifies the likelihood of individual words following each other in the speech to be recognized.

The aim of current improvements in speech recognition is to gradually achieve better speech recognition rates, i.e. to increase the likelihood that a word or speech command spoken by a user of the mobile communication device being recognized correctly.

Since this speech recognition has a multiplicity of uses, it is also used in environments which are adversely affected by noise. In this case the speech recognition rates fall drastically since the feature vectors to be found in the acoustic model, for example in the HMM, have been created on the basis of clean speech, i.e. speech untainted by noise. This leads to unsatisfactory speech recognition in loud environments, such as on the street, in busy buildings or also in the car.

Using this prior art as its starting point, the object of the invention is to create an option for also performing speech recognition with a high speech recognition rate in noisy environments.

This object is achieved by the features of the independent claims. Advantageous further developments are the object of the dependent claims.

The core of the invention is that processing of the speech signal is undertaken before this signal is routed to a speech recognition system for example. The speech signal undergoes noise suppression within the framework of this processing. Subsequently the speech signal is normalized as regards its signal level. The speech signal in this case comprises one or more speech commands.

This has the advantage that the speech recognition rates for a speech command for a speech signal with noise-tainted speech pre-processed in this manner are significantly higher than with conventional speech recognition with noise-tainted speech signals.

Optionally, after noise suppression, the speech signal can also be fed to a unit for determining the speech activity. On the basis of this noise-reduced speech signal it is then established whether speech or a pause between speech is present. Depending on this decision, the normalization factor for signal level normalization is then determined. In particular the normalization factor can be defined so that pauses between speech are more heavily suppressed. Thus the difference between speech signal sections in which speech is present and those sections in which no speech is present (pauses), becomes even more clear. This makes speech recognition easier.

A method with the features described above can also be applied to so-called distributed speech recognition systems. A distributed speech recognition system is characterized by not all steps within the framework of speech recognition being performed in the same component. More than one component is thus required. For example one component can be a communication device and a further component can be an element of a communication network. In this case for example the speech signal detection takes place in a communication device equipped as a mobile station, but the actual speech recognition on the other hand is undertaken in the communication network element on the network side.

This method can be applied both in speech recognition and also when the acoustic model is being created, for example an HMM. Application of the method during the creation of the acoustic model in conjunction with speech recognition, based on an inventively preprocessed signal, shows a further improvement in the speech recognition rate.

Further advantages of the invention are shown with reference to selected exemplary embodiments which are also illustrated in the Figures.

The figures show:

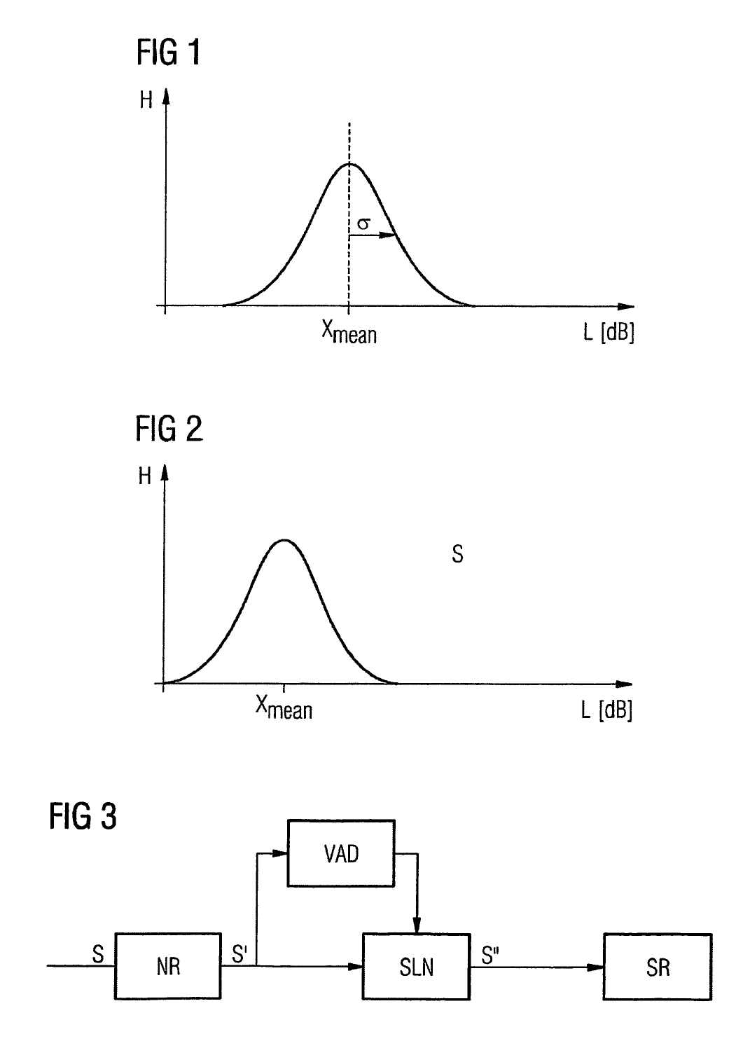

FIG. 1: a histogram in which speech signals containing one or more speech commands are plotted in relation to their signal level, for the case of training to create an acoustic model;

FIG. 2: a histogram of speech signals in relation to their signal level for the case of a speech recognition;

FIG. 3: a schematic embodiment of an inventive processing sequence;

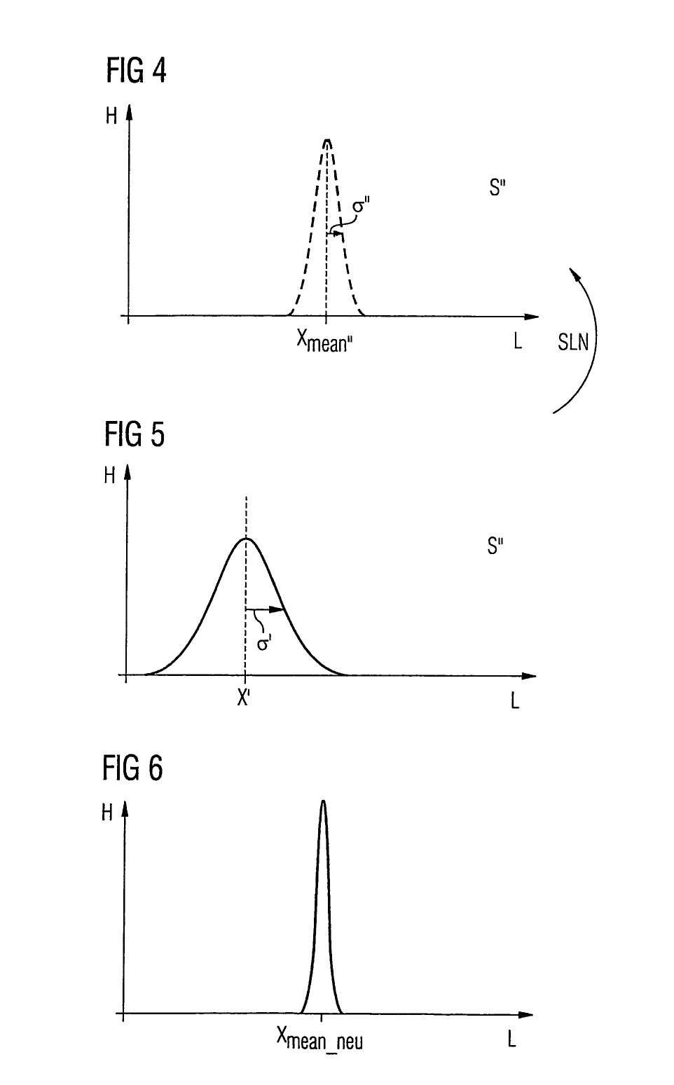

FIG. 4: a histogram, in which the noise-reduced and speech level-normalized speech signal is plotted against the speech signal level;

FIG. 5: a histogram, in which the noise-reduced speech signal is plotted against the signal level;

FIG. 6 a histogram, in which the speech signal is preprocessed in the training in accordance with the invention;

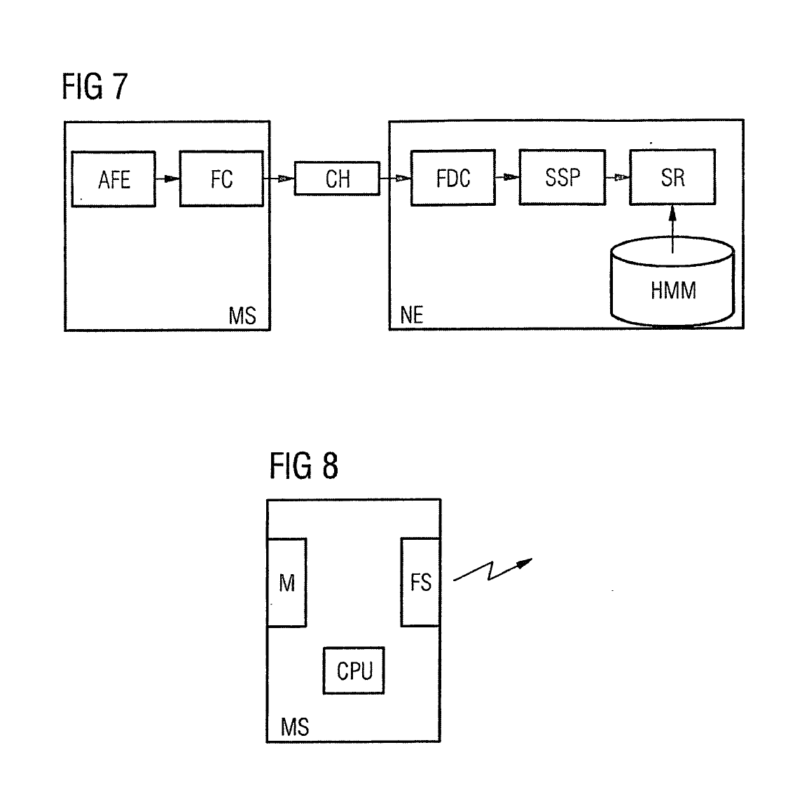

FIG. 7 a distributed speech processing scheme;

FIG. 8 an electrical device which can be used within the framework of distributed speech processing.

FIG. 8 shows an electrical device embodied as a mobile telephone or mobile station MS. It has a microphone M for accepting speech signals containing speech commands, a Central Processing Unit CPU for processing the speech signals and a radio interface FS for transmitting data, for example processed speech signals.

The electrical device can, on its own or in combination with other components, implement speech recognition with regard to the accepted or detected speech commands.

The detailed investigations which have led to the invention will now be presented:

FIG. 1 shows a histogram in which speech signals containing one or more speech commands are sorted in respect of their signal level L and this frequency H has been plotted against the signal level. In this case a speech signal S, as indicated in the following Figures for example, contains one or more speech commands. For the sake of simplicity it is assumed below that the speech signal contains a speech command. A speech command can for example be formed for an electrical device equipped as a mobile telephone by the request “call” as well as optionally by a specific name. A speech command must be trained for speech recognition, i.e. based on repeated speaking of the speech command one feature vector or a number, i.e. more than one feature vector is created. This training is undertaken within the framework of creating the acoustic model, for example the HMM, which occurs at the production stage. These feature vectors are included later for speech recognition.

The training of speech commands which is used for the creation of feature vectors is performed at a defined signal level or volume level (single level training). In order to exploit the dynamic range of the AD converter to convert the speech signal into a digital signal, the preferred operational level is around −26 dB. The definition in Decibels (dB) is produced by the bits available for signal level. Thus 0 dB would mean an overflow (that is exceeding the maximum volume or the maximum level). Alternatively instead of a single level training, training can be performed at a number of levels, for example at −16, −26 and −36 dB.

FIG. 1 in this case shows the frequency distribution of the speech level for a speech command for training.

A mean signal level Xₘₑₐₙ as well as a certain distribution of the levels of the speech signal is produced for a speech command. This can be represented as a Gaussian function with the mean signal level Xₘₑₐₙ and a variance σ.

After the distribution of the speech commands for the training situation has been seen in FIG. 1, the situation for speech recognition is shown in FIG. 2 which again presents the frequency H plotted against the signal level L in accordance with FIG. 1: Here the speech signal S′ with one or more speech commands, as is indicated in the subsequent Figures, is sorted as regards its signal level L and the frequency H is plotted. Because of the environmental effects, even after noise reduction NR has already been applied (cf. FIG. 3) a distribution shifted in relation to the training situation in FIG. 1 is produced, with a new mean signal level Xₘₑₐₙ shifted in relation to the mean value Xₘₑₐₙ in the training.

It has been shown in investigations that the speech recognition rate reduces drastically as a result of this shifted mean signal level Xₘₑₐₙ.

This can be seen from Table 1 below:

TABLE 1
Training with clean speech at different volume levels
or signal levels (multi-level).
The speech recognition rates relate to the test speech which
was normalized at the signal levels −16, −26, −36 dB.

| | Word recognition rates [%] | | | | | | | |
|---|---|---|---|---|---|---|---|---|
| Test speech | Subway | | Babble | | Car | | Exhibition | |
| Signal levels | Clean | 5 dB | Clean | 5 dB | Clean | 5 dB | Clean | 5 dB |
| −16 dB | 98.83 | 80.14 | 98.79 | 86.99 | 98.72 | 88.01 | 99.11 | 79.76 |
| −26 dB | 99.14 | 85.66 | 99.15 | 76.66 | 99.19 | 91.35 | 99.35 | 85.00 |
| −36 dB | 99.39 | 85.05 | 99.21 | 82.41 | 99.28 | 89.41 | 99.57 | 85.47 |

Table 1 lists the speech recognition rate or word recognition rate for different noise environments in which training with a clean speech at different volumes has been undertaken. The test speech, that is the speech signal from FIG. 1, has been normalized at three different levels at −16 dB, −26 dB and −36 dB. The speech recognition rates for different types of noises with a noise level of 5 dB are shown for this different test speech energy level. The different noises involved are typical background noises such as subway, so-called babble noise, e.g. a cafeteria environment with speech and other noises, the background noise in a car as well as the noise at an exhibition (i.e. similar to bubble noise, but worse, possible with announcements, music etc). It can be seen from Table 1 that speech recognition in noise-free speech is largely unaffected by variations in the test speech energy level. However for noise-tainted speech a significant reduction in speech recognition can be seen. The terminal-based pre-processing method AFE has been included for speech recognition here which is used to create the feature vectors.

For the speech recognition rates investigated in Table 1—which are still not satisfactory—the situation is however significantly improved compared to the speech recognition based on training with only one volume level.

In other words the effect which an ambient noise has on an acoustic model which was created on the basis of only one volume of the training speech is even more plainly detrimental.

This has led to the inventive improvements presented below:

FIG. 3 now presents the execution sequence in accordance with one exemplary embodiment of the invention. The speech command or speech signal S, e.g. a word spoken by a person, is subjected to a noise reduction NR. After this noise reduction NR a noise-reduced speech signal S′ is present.

The noise-reduced speech signal is subsequently subjected to a signal level normalization SLN. This normalization is used to establish a signal level which is comparable with the average signal level shown in FIG. 1 by Xₘₑₐₙ. It has been shown that higher speech recognition rates can be obtained for comparable mean signal levels. This means that the speech recognition rate is already increased by this shifting of the signal level.

After the signal level normalization SLN a normalized and noise-reduced speech signal S″ is present. This can be subsequently used for example for a speech recognition SR with a higher speech recognition rate than for original test speech tainted by noise.

Optionally the noise-reduced signal S′ is split up and also flows in addition to the signal level normalization SLN to a Voice Activity Detection VAD unit. Depending on whether speech or a speech pause is present, the normalization level with which the noise-reduced speech signal was normalized, is set. For example in speech pauses a smaller multiplicative normalization factor can be used by which the signal level of the noise-reduced speech signal S′ is reduced more in speech pauses than if speech is present. This means that a stronger distinction between speech, that is between individual speech commands for example and speech pauses is possible, which further greatly improves a downstream speech recognition as regards the speech recognition rate.

Furthermore there is provision to change the normalization factor not only between speech pauses and speech sections but also to vary it within a word for different speech sections. The speech recognition can also be improved in this way since a number of speech sections, because of the phonemes contained within them, exhibit a very high signal level, for example with plosive sounds (e.g. p), whereas others are rather inherently silent.

Different methods are employed for signal level normalization, for example a real-time energy normalization, as described in the Article “Robust Endpoint Detection and Energy Normalization for Real-Time Speech and Speaker recognition” by Qi Li et al. in IEEE Transactions on Speech and Audio Processing Vol. 10, No. 3, March 2002 in Section C (P. 149-150). A further signal level normalization method is described within the framework of the ITU, which can be found under ITU-T, “SVP56: The Speech Voltmeter”, in software Tool Library 2000 User's Manual, pages 151-161, Geneva. Switzerland, December 2000. The normalization described in this document works “off-line” or in what is known as “batch mode”, i.e. not simultaneously or contemporaneously with speech recognition.

For noise reduction NR (cf. FIG. 3) different known methods are also provided, for example methods operating in the frequency area One such method is described in “Computationally efficient speech enhancement using RLS and psycho-acoustic motivated algorithm” by Ch. Beaugeant et al. in Proceedings of 6th World Multi-conference on Systemics, Cybernetics and Informatics, Orlando 2002. The system described in this document is based on an analysis-by-synthesis system in which the parameters describing the (clean) speech signal and the noise signal are extracted frame-by frame recursively (cf. Section 2 “Noise Reduction in the Frequency Domain”, Section 3 “Recursive implementation of the least square algorithm” in this document). The clean speech signal thus obtained is further weighted (cf. Section 4 “Practical RLS Weighting Rule”) and an estimation of the power of the noise signal is undertaken (cf. Section 5 “Noise Power Estimation”). Optionally the results obtained can be refined by means of psychoacoustic motivated methods (Section 6: “Psychoacoustic motivated method”). Further noise reduction methods which can be included in accordance with an embodiment shown in FIG. 3 are for example described in ETSI ES 202 0505 V1.1.1 dated October 2002 in Section 5.1 (“Noise Reduction”).

An unprocessed speech signal S as regards noise reduction NR and signal normalization is used as the basis for the frequency distributions in FIGS. 1 (training situation) and 2 (test situation, i.e. for a speech recognition). The noise-reduced speech signal S′ is used as a basis for the frequency distribution in FIG. 5. The noise-reduced and signal-level-normalized signal is used as the basis for the distributions in FIGS. 4 (test situation) and 5 (training situation).

The idea underlying the schematic execution sequence shown in FIG. 3 of a speech signal processing for a subsequent speech recognition is presented in FIGS. 4 to 6.

FIG. 5 shows a frequency distribution for a noise-reduced speech signal S′ as occurs for example in FIG. 3 after the noise reduction NR. Compared to FIG. 2, which relates for example to the frequency distribution for a speech signal S shown in FIG. 3, a further noise reduction NR has thus been undertaken.

The center of the frequency distribution of this noise-reduced speech signal S′ compared to the speech level L is to be found at a mean level Xₘₑₐₙ. The distribution has a width σ′. In the transition to FIG. 4, signal normalization SLN is performed on the noise-reduced signal S′ shown in FIG. 5. This means for example that the speech signal used as a basis for the distribution in FIG. 4 would correspond to the noise-reduced and signal-level-normalized speech signal S″.

A signal level normalization brings the actual signal level in FIG. 5, to a desired signal level, for example the signal level obtained in training, indicated in FIG. 1 by Xₘₑₐₙ. Furthermore signal level normalization SLN leads to the distribution becoming narrower i.e. to σ″ being narrower than a′. This means that the mean signal level Xₘₑₐₙ″ in FIG. 4 can more easily be reconciled with the mean signal level Xₘₑₐₙ in FIG. 1, which was obtained in training. This leads to higher speech recognition rates.

The application of what has been explained above is now examined for speech recognition in conjunction with FIG. 7. As already explained at the start, the speech recognition can take place in one component or distributed amongst a number of components.

For example in an electrical device which is embodied as a mobile station MS there can been means for recognizing the speech signal, e.g. the microphone M shown in FIG. 8, means for a noise reduction NR and means the signal normalization SN. The latter can be implemented within the framework of the Central Processing Unit CPU. Thus the idea presented in FIG. 3 of speech signal processing in accordance with one embodiment of the invention as well as the subsequent speech recognition in a mobile station can be implemented on its own or in conjunction with an element of a communication network.

In accordance with an alternative embodiment the speech recognition SR (see FIG. 3) is even undertaken on the network side. To this end the feature vectors created from a speech signal S″ are transmitted via a channel, especially a radio channel to a central unit in the network. Here the speech recognition is undertaken on the basis of the transmitted feature vectors especially on the basis of the model created during production. During production can mean especially that the acoustic model is created by the network operator.

In particular the proposed speech recognition can be applied to speaker-Independent speech recognition as is for example undertaken within the framework of the so-called Aurora scenario.

A further improvement emerges in speech commands are already normalized when the acoustic model is created during production or during training in respect of the signal level. This means that the distribution of the signal level is namely narrower, by which an even better match between the distribution shown in FIG. 4 and the distribution achieved in the training is obtained. Such a distribution of the frequency H in relation to the signal level L for a speech command in training for which signal level normalization has already been performed, is shown in FIG. 6. The mean training level Xₘₑₐₙ_{_{—}}_{new} last produced matches the mean level Xₘₑₐₙ″ (FIG. 4) of the noise-reduced and signal-level-normalized speech signal S″ (FIG. 3). As has already been shown, a match in the mean levels is one of the criteria for a high speech recognition rate. Furthermore the width of the distribution in FIG. 6 is very narrow which makes it easier to reconcile this distribution with the distribution in FIG. 4, i.e. bring it to the same signal level.

FIG. 7 shows a Distributed Speech Recognition (DSR). A distributed speech recognition can for example be used within the framework of the AURORA project of the ETSI STQ (Speech Transmission Quality) already mentioned.

With a distributed speech recognition a speech signal, for example a speech command, is detected at a unit and feature vectors describing this speech signal are created. These feature vectors are transmitted to another unit, typically a network server. Here the feature vectors are processed and speech recognition is performed on the basis of these feature vectors.

FIG. 7 shows a mobile station MS as a first unit or component and a network element NE.

The mobile station MS, which is also referred to as a terminal, features means AFE for terminal-based preprocessing which are used to create the feature vectors. For example the mobile station MS is a mobile radio device, portable computer or any other mobile communication device. The means AFE for terminal-based preprocessing is for example the “Advanced Front End” discussed within the framework of the AURORA project.

The means AFE for terminal-based preprocessing comprises means for standard processing of speech signals. This standard speech processing is for example described in Specification ETSI ES 202050 V1.1.1 dated October 2002 in FIG. 4.1. On the mobile station side the standard speech processing includes feature extraction with the steps noise reduction, waveform processing, cepstrum calculation as well as blind equalization. Feature compression and preparation for transmission are subsequently undertaken. This processing is known to the person skilled in the art, for which reason it is not discussed in further detail here.

In accordance with an embodiment of the invention the means AFE for terminal-based preprocessing also comprises means for signal level normalization and voice activity detection in accordance with FIG. 3.

These means can be integrated into the AFE means or alternatively implemented as a separate component.

Using subsequent means FC for feature compression, terminal-based preprocessing AFE, the one or more feature vectors which are created from the speech command are compressed to allow them to be transmitted via a channel CH.

The other unit is for example formed by a network server as network element NE. In this network element NS the feature vectors are decompressed again using means FDC for feature vector decompression. In addition means SSP are used for server-side preprocessing, so that the means SR for speech recognition can then be used to perform speech recognition based on a Hidden Markov Model HMM.

The results of inventive improvements will now be explained: Speech recognition rates for different training of the speech commands as well as different speech levels or volumes which are included for speech recognition (test speech) are shown in Tables 1 to 2.

Table 2 now shows the speech recognition rates for different energy levels of the test speech. The training is undertaken at a speech energy level of −26 dB. The test speech has been subjected to noise suppression and speech level normalization in accordance with FIG. 3. It can be seen from Table 2 that the speech recognition rates for clean speech are again consistently high. The significant improvement compared to the previous speech recognition method lies in the fact that the difference which can be seen in Table 1 in the speech recognition rates for noise-tainted speech (for a signal-to-noise ratio” of 5 dB) is raised depending on the energy level of the test speech. The “Advanced Front End” described above is employed for speech recognition.

TABLE 2

| | Word Recognition Rates [%] | | | | | | | |
|---|---|---|---|---|---|---|---|---|
| Test Speech | Subway | | Babble | | Car | | Exhibition | |
| Energy levels | Clean | 5 dB | Clean | 5 dB | Clean | 5 dB | Clean | 5 dB |
| −16 dB | 99.45 | 83.79 | 98.85 | 75.63 | 99.02 | 86.34 | 99.35 | 79.67 |
| −26 dB | 99.20 | 84.71 | 98.88 | 74.37 | 99.05 | 87.89 | 99.32 | 80.56 |
| −36 dB | 98.86 | 84.71 | 98.70 | 75.00 | 98.78 | 87.77 | 99.01 | 80.47 |

1-15. (canceled)

16. A method of processing a noise-tainted speech signal for subsequent speech recognition, with the speech signal representing at least one speech command, the method which comprises:
a) acquiring the noise-affected speech signal;
b) subjecting the noise-affected speech signal to noise reduction for generating a noise-reduced speech signal; and
c) normalizing the noise-reduced speech signal with a normalization factor to a required signal level for generating a noise-reduced, normalized speech signal.

17. The method according to claim 16, which comprises defining a value of the normalization factor in dependence on a speech activity.

18. The method according to claim 17, which comprises determining the speech activity on a basis of the noise-reduced speech signal.

19. The method according to claim 16, which further comprises:
d) describing the noise-reduced, normalized speech command by one or more feature vectors.

20. The method according to claim 19, which comprises generating the one or more feature vectors to describe the noise-reduced, normalized speech command.

21. The method according to claim 16, which further comprises:
e) transmitting a signal describing the feature vector or the feature vectors.

22. The method according to claim 16, which further comprises:
f) performing speech recognition based on the noise-reduced, normalized speech command.

23. The method according to claim 22, which comprises acquiring the speech signal in step a) and performing the speech recognition in step f) at respectively separate locations.

24. The method according to claim 16, which comprises executing preprocessing and a feature compression of feature vectors describing a speech signal.

25. The method according to claim 24, which comprises executing the preprocessing and the feature compression at mutually different locations.

26. The method according to claim 24, which comprises executing the preprocessing and the feature compression at a common location.

27. The method of training a speech command in a noise-tainted speech signal, the method which comprises the following steps:
a′) acquiring the noise-tainted speech signal;
b′) subjecting the speech signal to noise reduction for generating a noise-reduced speech signal; and
c′) normalizing the noise-reduced speech signal by way of a normalization factor to a required signal level for generating a noise-reduced, normalized speech signal.

28. The method according to claim 27, which comprises training the speech command to create an acoustic model.

29. The method according to claim 28, which comprises creating a Hidden Markov Model.

30. An electrical device, comprising a central processing unit configured to execute the method according to claim 16, and a microphone connected to said central processing unit.

31. The electrical device according to claim 30, wherein said central processing unit is programmed to execute steps a), b), and c).

32. The electrical device according to claim 30, which further comprises a device for creating feature vectors for describing a speech signal.

33. A communication device, comprising a transmitting and receiving apparatus and an electrical device according to claim 30.

34. The communication device according to claim 33 configured as a mobile station.

35. A communication system, comprising: an electrical device according to claim 30 configured as a mobile station, and a communication network configured for execution of speech recognition.
